(19) United States
(12) Patent Application Publication
(10) Pub. No.: US 2001/0035824 A1
(43) Pub. Date: Nov. 1, 2001

(54) Infant monitoring and identification apparatus

(76) Inventors: Pieter Rousseau Fourie, Durbanville (ZA); Jacobus Adriaan Wessels, Bellville (ZA)

Correspondence Address: JACOBSON, PRICE, HOLMAN & STERN, PROFESSIONAL LIMITED LIABILITY COMPANY, THE JENIFER BUILDING, 400 SEVENTH STREET, N.W., WASHINGTON, DC, 20004, US

(21) Appl. No.: 09/836,327

(22) Filed: Apr. 18, 2001

Related U.S. Application Data
(63) Continuation-in-part of application No. 09/463,966, filed on Apr. 11, 2000, now abandoned.

(51) Int. Cl. G08B 23/00

(52) U.S. Cl. 340/573.4; 340/539; 340/572.1; 340/572.8; 340/572.9

(57) ABSTRACT

A system and component parts thereof are provided for monitoring a controlled area in a maternity or other healthcare facility. Access-ways to and from the controlled area are each provided with an access-way monitoring station and all infants and mothers subject to monitoring are provided with an infant mother station of a cooperant pair thereof. Each of the infant and mother rations has attachment means enabling secure attachment thereof to the body of the infant or mother. All stations have communication means enabling wireless communication of identification data directly between them. The infant and mother stations recognize unique identification data transmitted by one to the other of such stations, and indicator means such as an LED indicate that recognition of the unique identification data has taken place so as to result in positive identification to the mother station of the associated infant station. The access-way monitoring stations repeatedly interrogate all infant stations within a short range and check that the corresponding mother station is also present within that range. If not, an alarm is given.

### RELATED APPLICATION

This application is a continuation-in-part application of U.S. patent application Ser. No. 09/463,966 filed Apr, 11, 2000.

### FIELD OF INVENTION

This invention relates to an infant monitoring and identification apparatus and to a system of monitoring the movement of an infant from particular areas in a maternity or other healthcare facility for the purpose of guarding against the unauthorized removal of an infant from controlled areas in the facility and also for enabling secure identification of an infant by its mother and others to be achieved.

### BACKGROUND TO THE INVENTION

Abductions of newborn babies are not frequent occurrences, but when they do occur, the emotional trauma that inevitably results is almost impossible to quantify. In addition, such abductions expose maternity or other healthcare facilities to potential loss arising out of possible litigation and damage to their public image.

U.S. Pat. No. 4,899,134 to Wheeless describes a clamp for attachment to the umbilical cord of an infant so that movement of the infant past certain detection equipment, for example at a doorway, can alert staff at the facility of any attempts at unauthorized removal of an infant from the controlled area. The umbilical cord clamp embodies a transmitter which is detected at a receiving station. The system is quite simple and unsophisticated and does not address other possible irregularities or errors such as the exchanging of one infant for another or the mis-identification of mothers.

U.S. Pat. No. 6,084,513 to Stoffer describes a transponder tag for attachment to a person, in particular a patient, and in the present context, to an infant. The tag's whereabouts can be monitored by a somewhat complex system of overhead, spaced receivers so that the whereabouts of each tagged patient (infant) can be monitored, irregular movements detected, and suitable action taken. The system is costly, complicated, and involves considerable installation procedures within the maternity or other health care facility. The application of the tag to an infant is effected with adhesive material which enables removal of the tag to be detected.

### OBJECT OF THE INVENTION

It is thus an objective of this invention to provide monitoring apparatus and a system utilizing same which has enhanced features in comparison to those of either of U.S. Pat. Nos. 4,899,134 and 6,084,513 and which is simpler and less costly to implement than the latter.

### SUMMARY OF THE INVENTION

According to one aspect of this invention infant monitoring and identification apparatus comprises an infant station having attachment means enabling secure attachment thereof to the body of an infant and a separate cooperating mother station having attachment means enabling secure communication means enabling wireless communication of identification data directly between them, recognition means in at least one of the infant and mother stations for recognizing the identification data transmitted by the other of such stations, and indicator means for indicating that recognition of the data has taken place, the identification data being substantially unique to a particular mother station and associated infant station or stations so as to result in positive identification to the mother station of such infant station.

In use the mother station will be securely attached to the authorized nurturer of the infant, in most circumstances, the biological mother of the infant. It will, however be appreciated that in other unusual circumstances the mother station may be securely attached to other nurturers or care givers.

It must be understood that the expression “secure attachment” or any equivalent thereof is intended to mean that the station is adapted to be attached to the individual concerned in a manner such that removal thereof and possible replacement of the same station on another individual will either be impossible, which is preferable, or there will be clear evidence of such an eventuality. Generally, the attachment means will require fracture of a part such as a strap or breakage of a clip or catch holding the station in position in order to remove it.

Further features of the invention provide for both the infant station and the mother station to have both transmitter and receiver means, typically in the form of a transponder, at least in the case of the infant station; for the identification data transmitted from one station to the other to be embodied in a composite message in which the identification data itself assumes the form of an identification number and the identification number in the case of the infants station and the mother station is identical and requires simple comparison to achieve said recognition: for additional data contained in said composite message to identify the one as an infant station and the other as a mother station; for there to be more than one infant station associated with a particular mother station for use in multiple birth situations; for both mother and infant stations to be battery powered; for both stations to have indicator means for indicating mutual recognition of the associated stations, preferably such indicator means being in the form of light emitting diodes provided on each of the relevant stations; and for both infant and mother stations to be produced so as to be disposable after the battery life has expired. The battery is protected against discharge before it is required for service by a switch protection tag or other expedient which needs to be removed before the station is commissioned for use

Preferably, and in the interests of saving battery power, identification data is transmitted from the mother station in response to manual operation of an activating switch or the like so that battery power is only utilized when recognition is desired, at least insofar as this aspect of the invention is concerned The infant station is preferably adapted to transmit the fact of recognition only if there is a match of the identity numbers and not in the event that it receives a signal from any other mother station.

Preferably, a mother station together with generally one, but for use in multiple birth situations, more than one, associated infant station are programmed at factory level with matching identification numbers so that the stations are supplied as a matched set and the stations of any other set will not cooperate with stations of any other sets to indicate recognition. On a practical level, a 16 bit memory allocation to identification data provides about 4 billion different permutations and this is considered to be adequate to achieve practically entirely unique recognition between infant and mother stations.

It is, however, also within the scope of the invention that the mother and infant stations are programmed at the level of the facility in which they are to be used. This arrangement is not preferred because it is more open to errors and abuse and it also requires more sophisticated, and therefore more costly administration.

The range of the transmitters employed in the mother and infant stations may be rather limited and it considered that, for most practical purposes, a range as short as 500 mm will be adequate. With a range of this nature extremely small batteries can be employed. However, substantially longer ranges are also intended to fall within the general scope of the invention.

Preferably, in the case of the infant station, the secure attachment means comprises a clamp intended to be clamped around the umbilical cord of the infant at the time of birth and to remain secured to the remnant umbilical stump thereafter until it falls off in the normal course of events by which time the infant station will generally have served its purpose.

The umbilical stump monitor may include sensor means for sensing vital signs of the subject infant, the sensor means including breathing detection means, such as an accelerometer.

The mother station can be constituted by a portable transceiver and the secure attachment means may be an armband or a wristband of the general type that needs to be severed in order to remove it. The mother station is, as in the case of the infant station, supposed to be attached to the mother at the time of delivery of the infant.

As an alternative to the preferred simple form of the infant station it may, in addition to the umbilical stump monitor, incorporate a limb monitor that is adapted for secure attachment to a limb of the infant, the limb monitor comprising communication means capable of relaying communication between the umbilical stump monitor and the mother station.

In this form of the invention, the infant armband monitor may include one or more monitors adapted to monitor vital signs of the infant and to communicate data pertaining to such vital signs to the mother station. Such vital signs monitors could include an impedance monitor, which can serve as a breathing and heart rate monitor, or a separate heart rate monitor. Communication means between the limb monitor and the umbilical stump monitor is preferably limited on a fixed range basis.

The infant station may also be adapted, in appropriate situations to transmit an alarm activating signal in the event of detachment of the umbilical clamp from the umbilical stump of the infant; detachment of the infant armband monitor from the arm or leg of the infant; an abnormal increase in the distance between the umbilical stump monitor and the infant armband monitor; and an abnormal condition in one or more of the vital signs of the infant monitored by the system.

In accordance with a second aspect of the invention there is provided an access-way monitoring station having transmitter and receiver means for communication with infant and mother stations as defined above over a limited range which extends over at last the extent of an access-way to and from a controlled area, the transmitter means being operative to transmit repeated messages including data identifying it as an access-way monitoring station such messages being receivable by all infant stations within said range, the infant stations being programmed to identify such messages received as originating from an access-way monitoring station and to respond by transmitting a message embodying its unique identification data and wherein the receiver means is adapted to receive said infant station identifying messages from all infant stations within said limited range; the transmitter means being operative to thereafter send a message to each mother station associated with any responding infant station to trigger the mother station to respond by transmitting its unique identification data if it is also within said limited range, and alarm means for giving an alarm in the event of the infant and mother stations not being both within said range at the same time.

Further features of the access-way monitoring station provide for such a station to be a stand-alone station not directly connected in any way with other such access-way monitoring stations; for each access-way monitoring station to assume the form of an arch through which persons entering and leaving the controlled area must pass; for the access-way monitoring station to be powered by an electrical mains power supply by way of a suitable transformer and with a backup battery power supply; for each of such stations to include a computer or microprocessor controlled circuit preferably having memory storage means for recording movements of infant stations and also optionally, mother stations past the access-way monitoring station; and for a plurality of different alarms to be provided for selection according to the destination to or from which the access-way leads.

Programming of the various stations preferably includes a time delay feature so that responses to the various interrogating messages are transmitted only after a short time delay the extent of which is changed on a random or systematic basis from one message to the next. This feature avoids the simultaneous reception of responsive messages from a plurality of stations.

The invention also provides a system for monitoring a controlled area in a maternity or other healthcare facility wherein access-ways to and from a controlled area are each provided with an access-way monitoring station as defined above and all infants and mothers subject to monitoring are provided with an infant or mother station as defined above.

In order at the above and other features of the invention may be more fully understood one particular embodiment thereof will now be described with reference to the accompanying drawings.

### BRIEF DESCRIPTION OF THE DRAWINGS

FIG. 1 is an exploded perspective illustration of an infant station in the form of an umbilical clamp;

FIG. 2 is a perspective illustration of a mother station in the form of a wristband carrying a housing for the circuitry of the mother station;

FIG. 3 is a perspective illustration of an access-way monitoring station;

FIG. 4 illustrates the configuration of the message transmitted between the various stations;

FIG. 5 is a block diagram of the circuit of the transponder employed in the mother and infant stations;

FIG. 6 illustrates schematically the functioning of the system;

FIG. 7 illustrates schematically the recognition of one particular infant station in amongst others; and,

FIG. 8 illustrates schematically the functioning of an access-way monitoring station.

### DETAILED DESCRIPTION WITH REFERENCE TO THE DRAWINGS

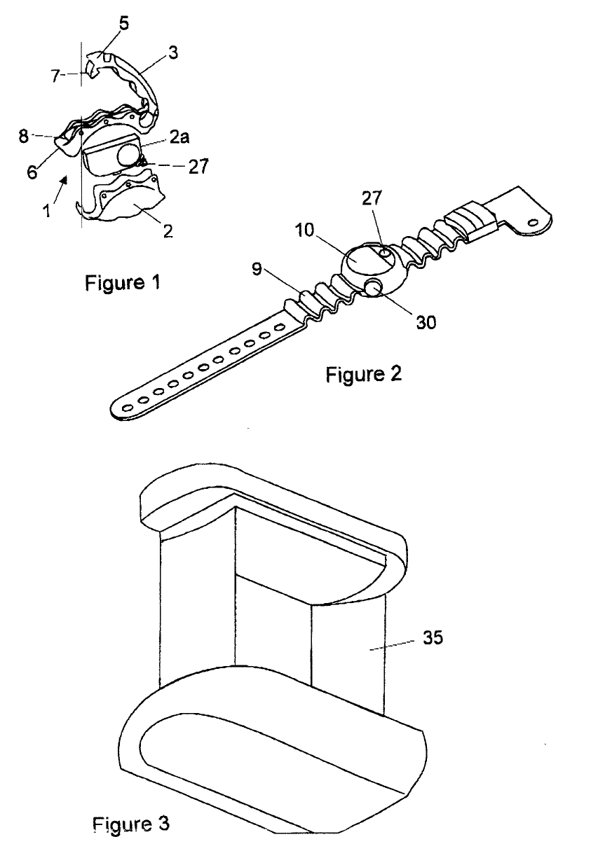

In this embodiment of the invention an infant station assumes the form of an umbilical clamp generally indicated by numeral (1) in FIG. 1. This clamp comprises a housing (2) forming associated with one of two hingedly attached jaws, the other of which is indicated by numeral (3). Opposed gripping means in the form of tooth-like formations (4) provide means for securely gripping the umbilical cord or stump of an infant when the jaws are moved together into a closed position of the clamp. The free ends (5) and (6) of the jaws have cooperating toothed spigot (7) and socket (8) formations which inter-engage in irreversible manner so that opening and removal of the clamp without breaking the spigot is not possible.

Within the housing and rendered sufficiently water-and tamper-proof, is located the electronic circuitry of the infant station as a unit (2a) and comprising the communication means, being a transponder and microprocessor means capable of responding to interrogation received from the cooperant mother station and an access-way monitoring station as will be more fully described below.

The mother station which is illustrated in FIG. 2 in this embodiment of the invention assumes the form of a wristband (9) that is configured for secure attachment to the arm of an infant's mother and which carries a housing (10) for the electronic circuitry of the mother station which is similar to that of the infant station.

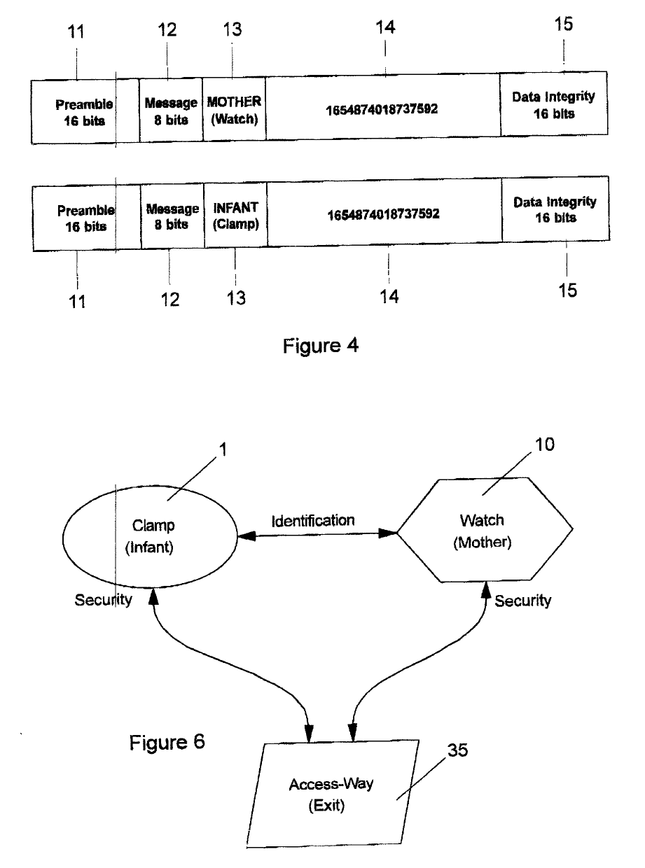

The electronic circuitry in each of the infant and mother stations is adapted to transmit a message from one to the other, and for simplicity, the message is a simple 80 bit message configured as indicated in FIG. 4. In this particular embodiment of the invention the first 16 bits indicated by numeral (11) functions as a preamble to establish synchronization and open the communication channel, The following 8 bits indicated by numeral (12) is employed to convey information as to the version of software being used; whether he set is one pertaining to a single infant, twins or triplets etc. and information as to the battery status. This is followed by a further 8 bit field indicated by numeral (13) which identifies the source of the message, particularly, whether it is from a mother station, an infant station, or an access-way monitoring station which is described further below.

The following 32 bits indicated by numeral (14) define the identification number of the particular mother station or infant station and it will be appreciated by those skilled in the art that 32 bits gives rise to some 4 billion permutations. Substantial uniqueness is thus not a problem. The final 16 bits indicates by numeral (15) is employed as a data integrity check in known manner.

In this embodiment of the invention identical identification numbers are employed in the mother station and each of the associated infant stations, if there be more than one. This enables the electronic circuitry of each station to simply check if the identification number received by it in any particular message is identical to the one contained in it and to respond as may be required and as will be further discussed below. The identification number is programmed into each of the mother and infant stations at factory level and from then on each set of mother station together with one or more infant stations is treated as a single item so that they do not become separated from each other. Such preprogrammed sets are an important feature of this invention.

One difference between the stations is that the mother station has a transmit facility to enable the triggering of the transmission of an interrogating message from the mother station to the infant station so as to illicit a response, or otherwise, as described further below.

Another difference is that the infant station is programmed to transmit its identification data containing message upon reception of an interrogating message from any access-way monitoring station as is further described below.

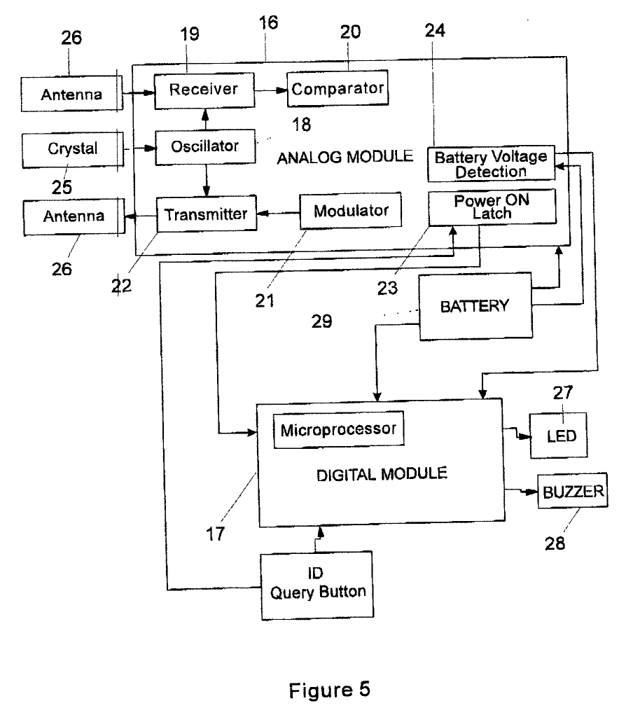

Referring now more particularly to FIG. 5, each of the electronic circuits comprises basically two modules indicated by numerals (16) and (17). The one module (16) is an analog module and provides the radio communications interface, and the other (17) is a digital module which provides control over the system's user interface.

The analog module is based on an application specific integrated circuit and includes an oscillator (18), a superheterodyne receiver (19), a carrier detect comparator (20), an fsk modulator (21), a transmitter output stage (22), a power-on latch (23) and a low battery detection circuit (24). This analog module also includes external components such as a 13.56 MHz crystal (25) and ferrite antennae (26) for the receiver and transmitter functions. The power-on latch circuit includes a low power carrier detect function to provide a sleep mode in order to minimize overall energy consumption. This circuit operates such that the receiver part of the circuit is always active but the transmitter part is only switched on when a signal from another source is detected and the transmission of a message embodying the code is required. After successful transmission of a message, at any time, the transmitter is shut down and the transponder returns to the sleep mode.

The digital module (17) is based on a commercial microprocessor and controls the clamp and watch user interface. The microprocessor activates an LED (27), one of which is provided in each of the mother and infant stations. A buzzer (28) is also provided where an audible alarm is required.

Each of the watch and the clamp circuits are powered from a single battery (29) conveniently in the form of a lithium cell. Such a battery provides, in this embodiment of the invention, for approximately a seven-day operational period which is considered adequate in view of the hospitalization period for a normal birth being of the order of three days.

The mother station is provided with a push button operated switch (30) so that a mother can activate the circuit in a mother station to transmit a message to a nearby infant station in order to check whether the infant station belongs to that mother station or, in other words, to check if the infant to which the relevant infant station is attached is indeed the child of the mother who is wearing the mother station. As indicated above the circuit in the infant station will be in a sleep mode when a message is received from a mother station. Following receipt of the message the circuit checks to see if the identification number embodied in the message is identical to that of the infant station itself and, only in the event that it is, does the transmit circuit power up and transmit the composite message embodying the unique identification code back to the mother station. Simultaneously the LED lights up momentarily to indicate the recognition and so does the LED in the mother station when the recognition message is received.

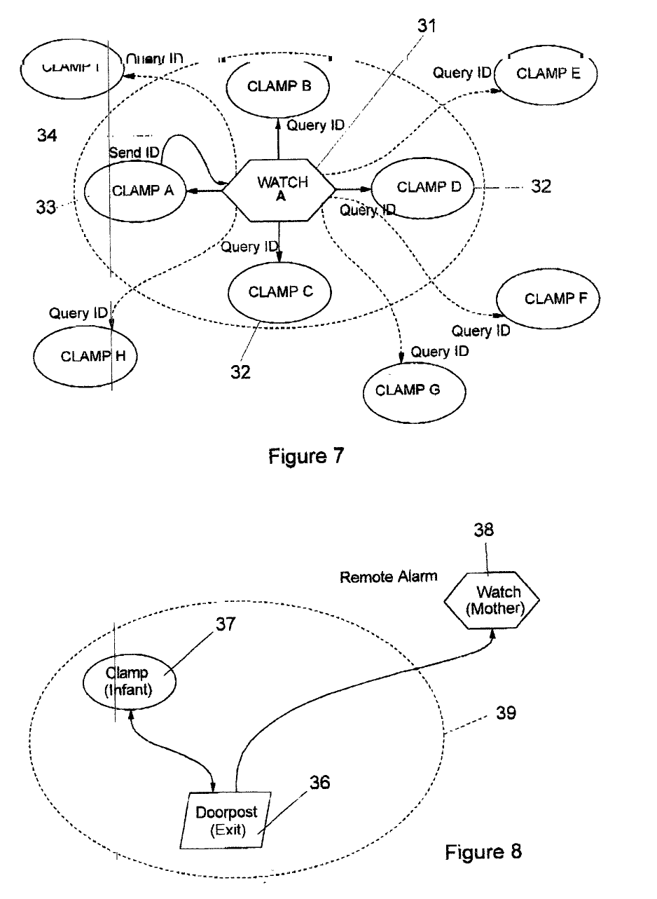

Insofar as the identification function is concerned it is illustrated basically in FIG. 7 which shows a mother station (31) which has transmit a message which could been received by various infant stations (32). However, on the basis described above, only the infant station (33) corresponding to that particular mother station will respond as indicated by numeral (34).

In its simplest form, the infant monitoring system of the invention therefore provides for positive identification of an infant.

In order to increase the utility of the system in guarding against abduction or the like here are provided access-way monitoring stations which may, as shown in FIG. 3, assume the simple form of a free standing arch (35). The access-way monitoring stations have basically the same type of circuitry as the mother and infant stations except for the fact that it embodies a general user interface and also the facilities for performing peripheral functions such as data logging. The microprocessor, in the case of the access-way monitoring stations, operates on a mains power supply through a suitable transformer and with a suitable battery backup system. This allows for the higher power signals which will be necessary for longer range communication as will become apparent from the following. The access-way monitoring station also has special loop antennae of known type and of which there are preferably three located in planes all at right angles to each other to ensure that signals from infant stations within the relevant range are properly received.

The circuitry of the access-way monitoring stations is adapted to send out messages to activate any infant station within the range of the access-way monitoring station to respond with its standard message including the unique identification number. This range is in this case about 2 meters. The infant stations are programmed to respond to every message received from an access-way monitoring station this being possible through recognition at the infant station of the 8 bit field described above which identifies the source of the interrogating message as being an access-way monitoring station. Preferably. As indicated above a variable time delay is programmed into the stations to avoid the simultaneous reception of a plurality of messages in response to an interrogating message.

Any infant station therefore being conveyed past an access-way monitoring station will immediately be interrogated to respond. When the standard message is received from the infant station the access-way station will immediately send out a message requiring the corresponding mother-station to respond. If no response is received from such a mother station the mother station and mother associated with it are presumed to be outside of the range and therefore not accompanying the infant to which the infant station is attached. The access-way station will then transmit a more powerful signal to the mother station and will also set off an alarm of some sort or another. Depending on the destination to which a particular access-way leads, the alarm could be a simple light flashing in the case of an internal destination or a siren in the case of an access-way to the outside of the facility.

The basic concept is illustrated in FIG. 8 which shows an access-way monitoring station (36) communicating with a infant station (37) in respect of which the mother station (38) is out of range as indicated by numeral (39).

In use, the system provided by the invention entails the application of an infant station to each infant and a mother station to each mother at birth at a maternity facility. The mother stations and infant stations may be supplied in sterile packaging which is only opened at the time of a birth. At that time a switch protection tag or other protective item is removed from each of the stations and the circuits activated, as may be necessary, by pressing on a switch for example. The two stations are checked to see if they are in communication prior to the infant station being clamped onto the infant's umbilical cord and the mother station being fixed to the mother's wrist.

Each access way whereby the unauthorized conveyance of an infant could take place is provided with a stand-alone access-way station as described above. To enhance the security of the system, the data communicated within the infant monitoring system may be rendered secure by means of secure data encryption as may be required.

What is claimed is:

1. Infant monitoring and identification apparatus comprising an infant station having attachment means enabling secure attachment thereof to the body of an infant and a separate cooperating mother station having attachment means enabling secure attachment thereof to the body of an adult, each station having communication means enabling wireless communication of identification data directly between them, recognition means in at least one of the infant and mother stations for recognizing the identification data transmitted by the other of such stations and indicator means for indicating that recognition of the data has taken place, the identification data being substantially unique to a particular mother station and associated infant station or stations so as to result in positive identification to the mother station of such infant station.

2. Infant monitoring and identification apparatus as claimed in claim 1 in which both the infant station and the mother station have both transmitter and receiver means.

3. Infant monitoring and identification apparatus as claimed in claim 1 in which the identification data to be transmitted from one station to the other is embodied in a composite message in which the identification data itself assumes the form of an identification number and the identification number in the case of the infant station and the mother station is identical and requires simple comparison to achieve said recognition.

4. Infant monitoring and identification apparatus as claimed in claim 3 in which additional data contained in said composite message serves to identify the one as an infant station and the other as a mother station.

5. Infant monitoring and identification apparatus as claimed in claim 1 in which both stations to have indicator means for indicating mutual recognition of the associated stations.

6. Infant monitoring and identification apparatus as claimed in claim 1 in which the mother station with together with generally one, but for use in multiple birth situations, more than one, associated infant stations are programmed at factory level with matching identification numbers so that the stations are supplied as a matched set and the stations of any other set will not cooperate with stations of any other sets to indicate recognition.

7. Infant monitoring and identification apparatus as claimed in claim 1 in which, in the case of the infant station, the secure attachment means comprises a clamp intended to be clamped around the umbilical cord of the infant at the time of birth and to remain secured to the remnant umbilical stump thereafter until it falls off in the normal course of events by which time the infant station will generally have served its purpose.

8. Infant monitoring and identification apparatus as claimed in claim 1 in which the mother station has secure attachment means in the form of a wristband of the general type that needs to be severed in order to remove it.

9. An access-way monitoring station having transmitter and receiver means for communication with infant and mother stations as defined above over a limited range which extends over at last the extent of an access-way to and from a controlled area, the transmitter means being operative to transmit repeated messages receivable by all infant stations within said range, the infant stations being programmed to identify such messages received as originating from an access-way monitoring station and to respond by transmitting a message embodying its unique identification data and wherein the receiver means is adapted to receive said infant station identifying messages from all infant stations within said limited range; the transmitter means being operative to thereafter send a message to each mother station associated with any responding infant station to trigger the mother station to respond by transmitting its unique identification data if it is also within said limited range, and alarm means for giving an alarm in the event of the infant and mother stations not being both within said range at the same time.

10. An access-way monitoring station as claimed in claim 9 in which the access-way monitoring station is adapted to transmit messages including data identifying it as an access-way monitoring station and thereby elicit a response from all infant stations within range, the infant stations being programmed to respond to any message received from an access-way monitoring station.

11. An access-way monitoring station as claimed in claim 9 in which the access-way monitoring station is adapted to be a stand-alone station not directly connected in any way with other such access-way monitoring stations.

12. An access-way monitoring station as claimed in claim 9 in which the station includes a computer or microprocessor controlled circuit having memory storage means for recording movements of infant stations and also, optionally, mother stations past the access-way monitoring station.

13. A system for monitoring a controlled area in a maternity or other healthcare facility wherein access-ways to and from a controlled area are each provided with an access-way monitoring station as claimed in claim 9 and all infants and mothers subject to monitoring are provided with an infant or mother station as claimed in claim 1.
